(19) United States
(12) Patent Application Publication
(10) Pub. No.: US 2010/0011229 A1
(43) Pub. Date: Jan. 14, 2010

(54) METHODS OF POWERING UP A DISK DRIVE STORAGE ENCLOSURE AND STORAGE ENCLOSURES

(75) Inventors: David Michael Davis, Hampshire (GB); Christopher John Nother, Hampshire (GB)

Correspondence Address: PILLSBURY WINTHROP SHAW PITTMAN, LLP, P.O. BOX 10500, MCLEAN, VA, 22102, US

(73) Assignee: Xyratex Technology Limited, Havant (GB)

(21) Appl. No.: 12/374,207

(22) PCT Filed: Jul. 13, 2007
(86) PCT No.: PCT/GB07/02626

§ 371 Date: Feb. 24, 2009

Related U.S. Application Data
(60) Provisional application No. 60/831,214, filed on Jul. 17, 2006.

(51) Int. Cl. G06F 1/00

(52) U.S. Cl. 713/300

(57) ABSTRACT

A method of powering up a disk drive storage enclosure is disclosed, the storage enclosure having at least one power supply and at least one module having a keyed readable interface corresponding to its power rating. The method includes: receiving a power-on signal; determining the power supplying capability of the storage enclosure; determining the power requirement of the storage enclosure including reading the keyed readable interface to determine the power rating of the at least one keyed module; determining the power mode attainable by the system in accordance with the power supplying capability and the power requirement, the modes including at least power on and power off; and, powering up or not powering up the storage enclosure in accordance with the power mode.

The present invention relates to methods of powering up a disk drive storage enclosure and to storage enclosures.

In disk drive mass storage systems it is known to removably mount disk drive assemblies in carriers and to removably mount the carriers in bays in a storage enclosure. The storage enclosure typically has a backplane and/or a midplane having a plurality of connectors, through which connection is made to corresponding connectors of the disk drive assemblies. The enclosure also typically has other bays for accepting various other modules. These can include one or more RAID controllers, enclosure management modules, cooling modules and power supply modules. These also generally include one or more input/output (I/O) modules, which generally provide connection to the disk drive modules and allow external connection to be made to the enclosure, and application modules, which normally perform some kind processing on the data transferred to and received from the disk drive modules. For example, application modules can implement a JBOD (“just a bunch of disks”) arrangement, SNA (storage network array) arrangement, etc. In some enclosures, the functionality of the application module is effectively incorporated into the I/O module. Thus references made herein to I/O modules should be interpreted as including I/O modules having the functionality of application modules unless the context demands otherwise.

Storage enclosures are typically highly modular, allowing various combinations and types of module to be present in the enclosure. For example, the disk drive units are usually hot-swappable, allowing individual disk drive units to be added or replaced from the enclosure during operation. Also, it is often possible to upgrade or change the functionality of the storage enclosure by adding new I/O modules or application modules. These are often warm-swappable. In addition, it is often possible to make components of the system redundant by providing extra modules which can be used to replace the functionality of a failed module in the event of a failure.

Due to this modularity, there can be a wide variation in the power required by the enclosure in order to meet the power requirements of all of the modules therein. This variation is exacerbated due to some modules having a wide variation in the power they require depending on their type. In particular, the input/output or application modules are likely to have a power requirement that varies considerably with type, depending upon the particular functionality that they provide. For example a module implementing JBOD (“just a bunch of disks”) is likely to have a relatively low power requirement of less than 30 W, whereas a module incorporating an embedded PC may require 100 W or more. The power required by a module can also vary depending on other factors. For example, the amount of power needed by a cooling module to cool the enclosure depends, among other things, on the number of disk drive modules in the enclosure that need to be cooled.

It is also known to provide redundancy to the power supply modules. N+1 redundancy is provided where N power supplies are sufficient to provide power to the enclosure and an additional power supply is provided so that a sufficient level of power can be maintained even in the event of failure of one of the power supplies. Similarly, N+2 redundancy provides two “extra” power supplies, N+N redundancy provides twice as many power supplies as are needed to power the enclosure, etc. Normally in a redundant system, the power supplies are hot-swappable, so that individual power supplies can be replaced without having to power down the enclosure or interrupt storage/retrieval of data.

Thus, within a storage enclosure, there can be a large degree of variation in the total power supplying capability of the power supply units and the level of redundancy attainable by them, and also there can be a large degree of variation in the power required to power the non-power-supplying modules within the storage enclosure. As a result, it is difficult for the system to determine the power requirements and the power supplying capability of the enclosure, and which level of redundancy can be achieved. This is potentially critical, since undesirable results are likely if the system tries to power up without enough power being available. This includes damage to equipment and unpredictable performance of hardware, leading to data loss and/or unavailability of data storage.

The known solution to address this problem is to calculate the maximum possible power requirement of the system in advance and to provide a sufficient number of power supplies that are powerful enough to power the enclosure and to provide whichever level of redundancy is required. However, this frequently results in excess power being made available than is in fact used, and hence additional cost. Also, this system is not capable of automatically adapting to a changed configuration in the enclosure, such as the addition of new modules, or the replacement of modules with higher power rated modules. It is therefore not possible to efficiently use the resources of the enclosure or to prevent damage by powering up the enclosure when not enough power is available. There is also no way of communicating the state of the power supply back to the user or the management function of the enclosure. What is needed therefore, is a power control system that is suited to and able to react to the highly modular nature of a typical storage enclosure.

According to a first aspect of the present invention, there is provided a method of powering up a disk drive storage enclosure, the enclosure having at least one power supply and at least one module having a keyed readable interface corresponding to its power rating, the method comprising: receiving a power-on signal; determining the power supplying capability of the enclosure; determining the power requirement of the enclosure including reading the keyed readable interface to determine the power rating of the at least one keyed module; determining the power mode attainable by the system in accordance with the power supplying capability and the power requirement, the modes including at least power on and power off; and, powering up or not powering up the storage enclosure in accordance with said power mode.

This allows the enclosure to determine whether or not it has enough power that can be supplied by its power supply modules to power the modules in the enclosure, and to power up the enclosure accordingly. The keyed interface allows the power requirement of that module to be determined by the system, allowing different modules with widely ranging power requirement to be used with the enclosure. The enclosure can thus safely power up or not despite a large potential for variation in the power supply capability of the enclosure and the power requirements of the modules of the enclosure. This provides a more efficient power supply arrangement, more suited to a highly modular storage enclosure capable of accepting, for example, various numbers of disk drive modules, various numbers of power supply modules and input/output modules of various power requirements.

In an embodiment, the at least one power supply has a keyed readable interface corresponding to its power output rating, the step of determining the power supplying capability of the enclosure including reading the keyed readable interface of said at least one power supply to determine the power output rating of the at least one power supply.

This allows the system to more accurately determine whether or not it has enough power supplied by its power supply modules to power the modules in the enclosure, where the enclosure is capable of accepting power supply modules capable of supplying different power levels.

According to a second aspect of the present invention, there is provided a method of powering up a disk drive storage enclosure, the enclosure having at least one power supply having a keyed readable interface corresponding to its power output rating and at least one module, the method comprising: receiving a power-on signal; determining the power supplying capability of the enclosure including reading the keyed readable interface of said at least one power supply to determine the power output rating of the at least one power supply; determining the power requirement of the enclosure; determining the power mode attainable by the system in accordance with the power supplying capability and the power requirement, the modes including at least power on and power off; and, powering up or not powering up the storage enclosure in accordance with said power mode.

This allows the enclosure to determine whether or not it has enough power supplied by its power supply modules to power the modules in the enclosure, and to power up the enclosure accordingly. The keyed interface allows the system to more accurately determine whether or not it has enough power where the enclosure is capable of accepting power supply modules capable of supplying different power levels.

The at least one module may comprise one or more of: a disk drive assembly module, an application module, a cooling module, a RAID controller module, an enclosure management module, and an input/output module.

In an embodiment, the enclosure has at least two power supplies and the power modes include power on in redundant power mode and power on in non-redundant power mode. This provides more flexibility for the power control of the enclosure.

In an embodiment, the enclosure has at least one module having a predetermined power rating and no keyed interface, wherein determining the power requirement includes: detecting the presence of said at least one module with a predetermined power rating. Some types of module may not have greatly varying power requirements. In these cases, it is not preferred to provide power keying of the relevant module, but instead the power requirement of the module can be determined by detecting the presence of the module and combining this information with the predetermined power requirement of that module type.

Preferably, the enclosure comprises control logic providing a truth table containing entries for at least some possible combinations of modules with a power key and modules with a predetermined power rating, the power mode being determined by looking up the appropriate entry in the truth table. This enables the calculation of the system power mode to be implemented in logic, such as complex programmable logic devices (CPLD). This logic is quick to initiate upon power up of the enclosure, so that the calculation can be performed speedily.

In an embodiment, the method comprises: signalling the power mode to an enclosure management module; and, displaying diagnostics information to a user based on the power mode.

In an embodiment, the at least one power supply has a standby voltage, wherein power control circuitry performs the method steps as described above, the method comprising: supplying the power control circuitry with power from the standby voltage of the at least one power supply; and then, performing the method steps as described above, wherein powering up includes sending a power enable signal to the power supply to supply power to the enclosure.

In a preferred embodiment, the enclosure comprises at least one disk drive module, and power control circuitry performs the method steps as described above, the method comprising: after the step of receiving the power on signal, enabling the at least one power supply to supply power to the power control circuitry; performing the method steps as described above, wherein powering up includes selectively enabling said at least one disk drive module and signalling the power supply to latch its output.

The enclosure may have an input/output module and the power control logic is on the input/output module.

According to a third aspect of the present invention, there is provided a storage enclosure for storage of disk drive assemblies, the enclosure comprising: at least one bay for receiving a keyed module; at least one bay for receiving a power supply module; and, power control circuitry, wherein the power control circuitry is arranged to: determine the power supplying capability of the enclosure; determine the power requirement of the enclosure including reading a keyed readable interface of a said at least one keyed module received in a said bay to determine the power rating of the at least one keyed module; determine the power mode attainable by the system in accordance with the power supplying capability and the power requirement, the modes including at least power on and power off; and, power up or not power up the storage enclosure in accordance with said power mode.

According to a fourth aspect of the present invention, there is provided a storage enclosure for storage of disk drive assemblies, the enclosure comprising: at least one bay for receiving a keyed module; at least one bay for receiving a power supply module; and, power control circuitry, wherein the power control circuitry is arranged to: determine the power supplying capability of the enclosure including reading a keyed readable interface of a said at least one power supply to determine the power rating of the at least one power supply; determine the power requirement of the enclosure; determine the power mode attainable by the system in accordance with the power supplying capability and the power requirement, the modes including at least power on and power off; and, power up or not power up the storage enclosure in accordance with said power mode.

Embodiments of the present invention will now be described by way of example with reference to the accompanying drawings, in which:

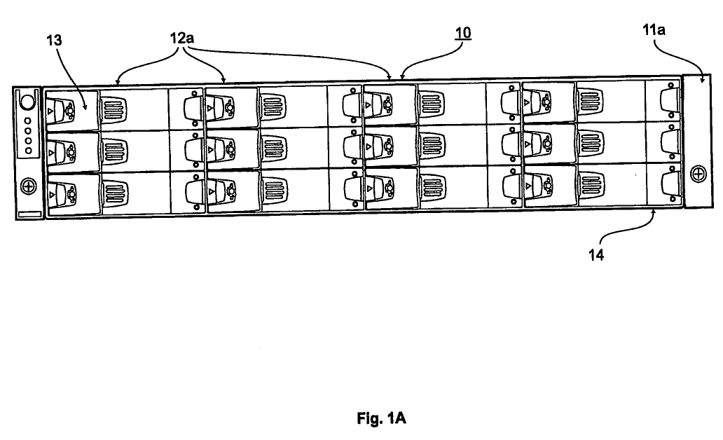

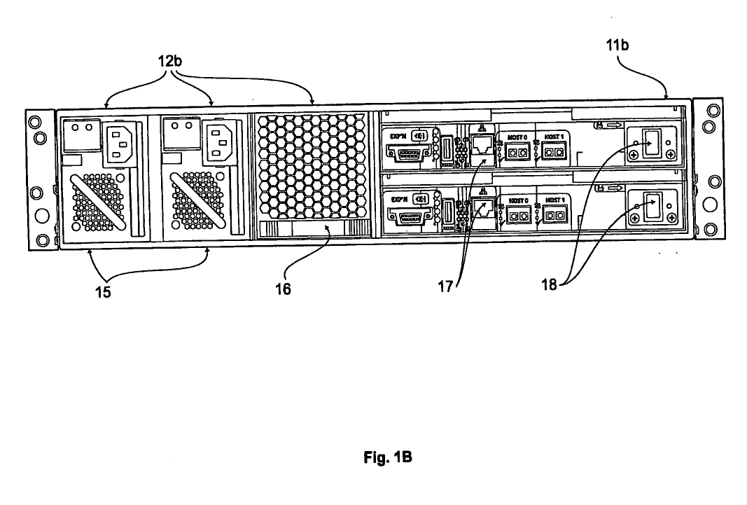

FIG. 1a shows an example of a storage assembly in accordance with an embodiment of the present invention viewed from the front, and FIG. 1b shows a view of the storage assembly from the rear;

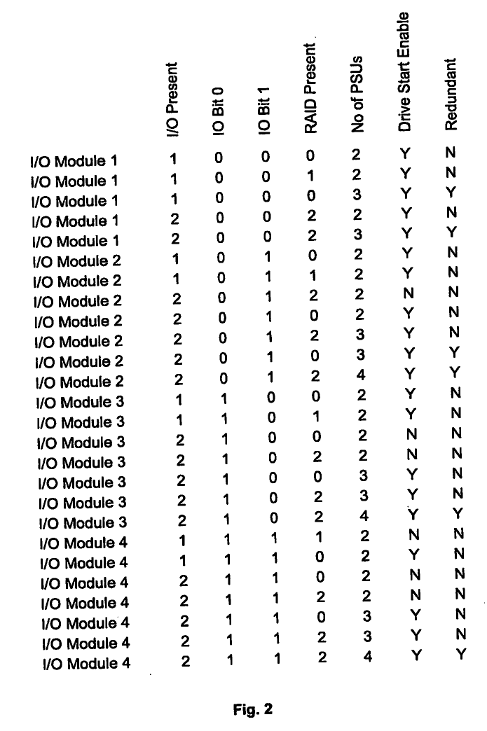

FIG. 2 shows an example of a truth table of the storage assembly of FIGS. 1a and 1b; and,

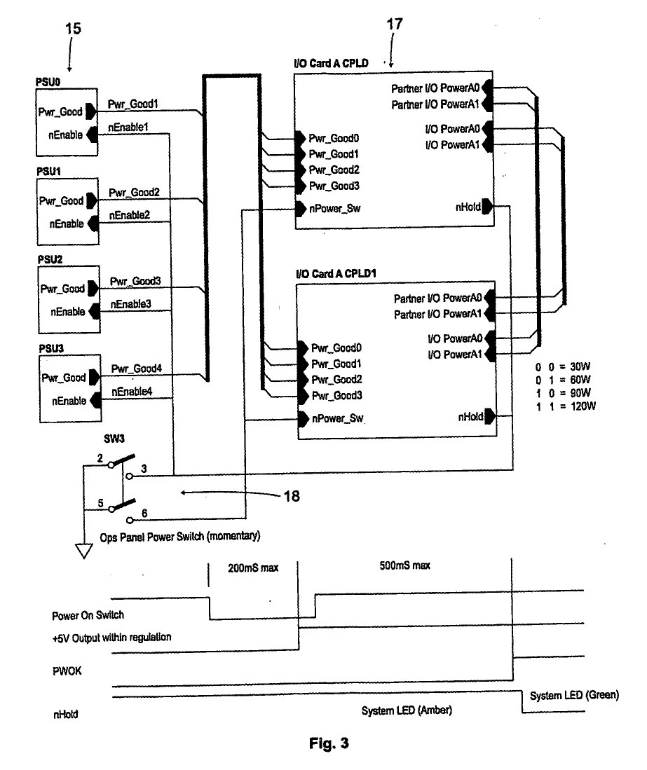

FIG. 3 shows a circuit diagram of power control circuitry of the storage assembly of FIGS. 1a and 1b.

FIGS. 1a and 1b show a disk drive storage enclosure 10 having a chassis 11a, 11b for mounting in a rack, such as a standard 19 inch (approx 48 cm) rack assembly (not shown). The front part of the chassis 11a has a plurality of bays 12a for receiving disk drive modules 13 or other modules. Each disk drive module 13 consists of a disk drive assembly (which includes one or more hard disks, one or more read/write heads, and drive motors) mounted in a disk drive carrier. The storage assembly 10 may also be provided with one or more RAID controllers 14 for configuring the plurality of disk drives as a RAID array.

As shown in FIG. 1b, the rear part of the chassis 11b has a plurality of bays 12b. Within the bays 12b are mounted two power supply units 15, a cooling/fan module 16 and two input/output modules (I/O modules) 17. In other embodiments, other modules may be present in the enclosure 10, such as application modules, enclosure management modules, etc.

Generally between the front and rear parts of the chassis 11a, 11b is positioned a backplane (not shown) (which, as used herein, includes a “midplane” or similar connection plane). The disk drive modules 13 and various other modules connect to the backplane through connectors. The backplane generally distributes power and data and control signals between the disk drive modules 13 and various other modules.

The enclosure also comprises power control circuitry 20 (shown in FIG. 3). Preferably the power control circuitry 20 is located in one of the input/output modules 17, although the power control circuitry may be alternatively located on the backplane or on another module.

The I/O modules 17 are in electrical connection with the backplane of the storage enclosure 10. The I/O modules 17 can be of various types and can implement various functionality for the enclosure. For example, the I/O modules 17 can implement JBOD (“just a bunch of disks”) configuration, NAS (network attached storage), SNA (storage network array), SCSI controllers or an embedded PC. In some embodiments, the separate application modules may be provided in addition to the I/O modules 17 to provide this functionality; the I/O modules providing communication of data with the disk drive modules 13 and one or more hosts attached to the storage enclosure 10, and the application modules providing more complex functionality. Depending on the type, the power required by the I/O modules 17 can vary considerably, for example anywhere between about 30 W to 120 W or more.

The I/O modules 17 each have two pins which are electrically readable by the power control circuitry 20 and which “key” or encode information about the power requirement of the module. The following table shows how the power rating of each I/O module 17 may be encoded.

TABLE 1

| | Bit 1 | Bit 0 | Power Rating (W) |
|---|---|---|---|
| Module Type 1 | 0 | 0 | 30 |
| Module Type 2 | 0 | 1 | 60 |
| Module Type 3 | 1 | 0 | 90 |
| Module Type 4 | 1 | 1 | 120 |

Thus, for example, an I/O module 17 with power rating pins set to binary 10 (i.e. module type 3) would require up to 90 W of power from the enclosure 10. Note that in this example, the power ratings are quantised to 30 W increments. However, other quantisations are equally possible. It is also possible to use any practicable number of pins for encoding the power rating. When the enclosure 10 is powered up, the power control circuitry 20 senses the voltage level of the two power rating pins of the I/O modules 17 to determine the power rating of the I/O modules 17.

For other modules in the enclosure 10 that are not power-keyed, for example the disk drive modules 13, the power control circuitry 20 detects the presence or not of each module. This can be achieved by conventional means. For example, the backplane connection to the disk drive module 13 can have a pin that is pulled HI by the backplane. When a disk drive module 13 is connected, the pin is pulled LO by the disk drive module 13 connecting thereto. This change in logic level can then be detected by the power control circuitry 20. The power rating of each of these modules is predetermined and known to the power control circuitry 20. Thus the power control circuitry 20 can determine the total power requirement of the enclosure 10 whatever the configuration.

The power control circuitry 20 also calculates the power supplying capability of the power supply modules 15 by detecting the presence of each power supply module 15 and referring to its predetermined power supplying rating. In a typical system, each power supply module 15 may be capable of supplying 355 W.

The power control circuitry 20 then refers to a lookup table to find if the enclosure has enough power to power up or not, and if so, whether redundancy can be achieved. FIG. 2 shows an example of a lookup table. In this example, the enclosure 10 has capacity for 24 disk drive modules 13 each with a predetermined power rating of 19 W and two cooling modules 16 each with a predetermined power rating of 50 W each. (Note, for clarity FIG. 1 shows an enclosure having fewer bays/modules than this.) In this example, it is assumed that the enclosure 10 is fully populated by disk drive modules 13 and cooling modules 16 so as to save space in the truth table. However, entries can be added to the truth table to take into account number of modules present for any module type. Each of the RAID controller modules 14, if present, has a predetermined power rating of 40 W. The I/O modules 17 are keyed with the coding shown in FIG. 2 and previously described. The power supply modules 15 are each capable of supplying 355 W. This information allows a truth table for the enclosure to be drawn up and stored with the power control circuitry 20 which holds entries of some or all allowable power states of the enclosure 10. In particular, the look up values provide for “drive start up”, i.e. there is enough power to start up the system, and “redundancy”, i.e. there is enough power to cope with the loss of at least one power supply module 15.

Thus, in the case where the enclosure 10 has two RAID arrays 14, two I/O modules 17 having power keying detected as binary 00, i.e. 30 W each (see Table 1 above), and two power supplies 15, this corresponds to the fourth row of the truth table. Thus it can be determined from the truth table that there is enough power for the system to start up, but not enough to provide redundancy.

If desired, the power up state can be communicated to a enclosure management function of the enclosure 10, for example as may be provided on a separate enclosure management module or on another module, to allow this information to be used in diagnosing any problems with the enclosure. This information may also be communicated to the user, for example by lighting LED indicators signifying the power-on state of the enclosure 10.

It is preferred to implement a truth table in calculating the power mode of the enclosure 10. However, other ways of calculating the power mode are possible, for example by totaling the power required by all of the modules in the enclosure 10, totaling the power supplying capability of the enclosure 10 and comparing the two totals. Use of a truth table is preferred, since the power control circuitry 20 needed to read the truth table can be implemented in logic, such as CPLD (complex programmable logic device). This allows the power mode to be determined relatively quickly by the power control circuitry 20 upon power being supplied to the control circuitry 20. In contrast, other methods of determining the power mode would need a microcontroller, which would take a relatively long time to initialise when power was supplied to the power control circuitry 20, thereby slowing down the power-up of the enclosure 10.

The power control circuitry 20 can in principle be located anywhere in the enclosure 10, for example on the backplane or on any of the modules. It is preferred however, to provide the power control circuitry 20 on the I/O module 17 itself. This is because the system will generally always have an I/O module 17 of some sort, and the I/O module 17 will generally already have connections to the disk drive modules 13 via the backplane. Also, one fewer entry is needed in the truth table by incorporating the circuitry 20 in an existing module, since its power requirement is fixed and known to it.

The series of operations in the power up cycle are as follows. The process is initiated by the enclosure 10 receiving a power on signal, typically from a user pressing and holding for a period of time a power button 18. If there is a standby voltage available from one or more of the power supply modules 15 in the enclosure 10 then this voltage is supplied to the power control circuitry 20. This enables the power control circuitry 20 to receive power independently of whether or not power is supplied to the rest of the enclosure 10, allowing the power control circuitry 20 to determine beforehand whether or not the enclosure 10 can be powered up. If it is determined by the power control circuitry 20 that the system has sufficient power to power up, the power control circuitry 20 sends a power enable signal (nEnable1 . . . 4) to some or all of the power supply modules 15 to cause the power to be provided to the other modules of the enclosure 10.

When the power supply modules 15 do not provide standby voltage, then the power control circuitry 20 is preferably arranged as shown in FIG. 3. When the user presses and holds the power button 18, the power supply modules 15 receive an enable signal (NEnable1 . . . 4) and begin to start up. It takes a finite time before the voltages supplied by the power supply modules 15 become dependable, at which point the power good signal (PWR_Good1 . . . 4) for each power supply module 15 becomes asserted. Power from the power supply modules 15 is arranged to be supplied to the power control circuitry 20, the I/O modules 17, the cooling modules 16 and the RAID modules 14. However, the disk drive modules 13 are not enabled at this point.

Once the power control circuitry 20 senses that the PWR_Good signals become asserted, indicating that the power supply voltages are dependable, then the power control circuitry 20 determines the power start-up mode, as described above. If it is determined that the enclosure 10 has sufficient power, then the power control circuitry 20 signals the disk drive assemblies in the disk drive modules 13 to spin-up and latches the nHold signal of the power supply modules 15 so that the power supply modules 15 will remain enabled when the user releases the power button 18. If it is determined that there is insufficient power for the enclosure to start up, then the disk drive units 13 are not spun-up, and the nHold signal is not latched, so that the enclosure 10 powers down when the user releases the power button 18.

In the present example, only the I/O modules 17 are keyed so as to allow their power rating to be determined by the power control circuitry 20, whereas the other modules in the enclosure 10 have their power rating determined by detecting the presence or not of the module and then including into the reckoning the predetermined power rating for that type of module. The I/O modules 17 are power-keyed in this way because the I/O modules 17 typically have the largest variance in power rating, and therefore it is most important for the system to be able to read the individual power rating for these modules, rather than relying on a predetermined value. However, as the skilled person would readily understand, the principle of power keying is not limited to the I/O modules 17, but could be applied to any other module in the same manner as to the I/O module 17 if this is desired. Similarly, each of the power supply modules 15 could be power keyed to allow the power control circuitry 20 to determine the power supplying capability of the power supply modules 15.

Embodiments of the present invention have been described with particular reference to the examples illustrated. However, it will be appreciated that variations and modifications may be made to the examples described within the scope of the present invention.

1. A method of powering up a disk drive storage enclosure, the storage enclosure having at least one power supply and at least one module having a keyed readable interface corresponding to its power rating, the method comprising:
receiving a power-on signal;
determining the power supplying capability of the storage enclosure;
determining the power requirement of the storage enclosure including reading the keyed readable interface to determine the power rating of the at least one keyed module;
determining the power mode attainable by the system in accordance with the power supplying capability and the power requirement, the modes including at least power on and power off; and,
powering up or not powering up the storage enclosure in accordance with said power mode.

2. A method according to claim 1, wherein the at least one power supply has a keyed readable interface corresponding to its power output rating, the step of determining the power supplying capability of the storage enclosure including reading the keyed readable interface of said at least one power supply to determine the power output rating of the at least one power supply.

3. A method of powering up a disk drive storage enclosure, the storage enclosure having at least one power supply having a keyed readable interface corresponding to its power output rating and at least one module, the method comprising:
receiving a power-on signal;
determining the power supplying capability of the storage enclosure including reading the keyed readable interface of said at least one power supply to determine the power output rating of the at least one power supply;
determining the power requirement of the storage enclosure;
determining the power mode attainable by the system in accordance with the power supplying capability and the power requirement, the modes including at least power on and power off; and,
powering up or not powering up the storage enclosure in accordance with said power mode.

4. A method according to claim 1, wherein the at least one module comprises one or more of: a disk drive assembly module, a cooling module, an application module, a RAID controller module, an enclosure management module, and an input/output module.

5. A method according to claim 1, wherein the storage enclosure has at least two power supplies and the power modes include power on in redundant power mode and power on in non-redundant power mode.

6. A method according to claim 1, wherein the storage enclosure has at least one module having a predetermined power rating and no keyed interface, wherein determining the power requirement includes:
detecting the presence of said at least one module with a predetermined power rating.

7. A method according to claim 1, wherein the storage enclosure comprises control logic providing a truth table containing entries for at least some possible combinations of modules with a power key and modules with a predetermined power rating, the power mode being determined by looking up the appropriate entry in the truth table.

8. A method according to claim 1, comprising:
signalling the power mode to an enclosure management module; and,
displaying diagnostics information to a user based on the power mode.

9. A method according to claim 1, wherein at least one power supply has a standby voltage, wherein power control circuitry performs the steps of claim 1, the method comprising:
supplying the power control circuitry with power from the standby voltage of the at least one power supply; and then,
performing the steps of claim 1, wherein powering up includes sending a power enable signal to the power supply to supply power to the storage enclosure.

10. A method according to claim 1, wherein the storage enclosure comprises at least one disk drive module, and power control circuitry performs the steps of claim 1, the method comprising:
after the step of receiving the power on signal, supplying power to the power control circuitry;
performing the steps of claim 1, wherein powering up includes selectively enabling said at least one disk drive module and signalling the power supply to latch its output.

11. A method according to claim 9, wherein the storage enclosure has an input/output module and the power control logic is on the input/output module.

12. A storage enclosure for storage of disk drive assemblies, the enclosure comprising:
at least one bay for receiving a keyed module;
at least one bay for receiving a power supply module; and,
power control circuitry,
wherein the power control circuitry is arranged to:
determine the power supplying capability of the storage enclosure;
determine the power requirement of the storage enclosure including reading a keyed readable interface of said at least one keyed module received in said bay to determine the power rating of the at least one keyed module;
determine the power mode attainable by the system in accordance with the power supplying capability and the power requirement, the modes including at least power on and power off; and,
power up or not power up the storage enclosure in accordance with said power mode.

13. A storage enclosure according to claim 12, wherein the power control circuitry is arranged to read a keyed readable interface of said at least one power supply to determine the power output rating of the at least one power supply.

14. A storage enclosure for storage of disk drive assemblies, the enclosure comprising:
at least one bay for receiving a keyed module;
at least one bay for receiving a power supply module; and,
power control circuitry,
wherein the power control circuitry is arranged to:
determine the power supplying capability of the storage enclosure including reading a keyed readable interface of said at least one power supply received in said bay to determine the power rating of the at least one power supply;
determine the power requirement of the storage enclosure;
determine the power mode attainable by the system in accordance with the power supplying capability and the power requirement, the modes including at least power on and power off; and,
power up or not power up the storage enclosure in accordance with said power mode.

15. A storage enclosure according to claim 12, having at least one keyed module received in a bay, wherein the module comprises one or more of: a disk drive assembly module, a cooling module, a RAID controller module, an enclosure management module, and an input/output module.

16. A storage enclosure according to claim 12, wherein the storage enclosure is arranged to receive at least two power supplies and the power modes include power on in redundant power mode and power on in non-redundant power mode.

17. A storage enclosure according to claim 12, wherein the power control circuitry is arranged to detect the presence of at least one module having a predetermined power rating and no keyed interface to determine the power rating of that module.

18. A storage enclosure according to claim 12, comprising control logic providing a truth table containing entries for at least some possible combinations of modules with a power key and modules with a predetermined power rating, the power control circuitry being arranged to determine the power mode by looking up the appropriate entry in the truth table.

19. A storage enclosure according to claim 12, wherein the power control circuitry is arranged to signal the power mode to an enclosure management module.

20. A storage enclosure according to claim 12, wherein the storage enclosure has an input/output module and the power control logic is on the input/output module.

21. A storage enclosure according to claim 12, and at least one power supply received in a bay and having a standby voltage, wherein the power control circuitry is arranged to receive power from the standby voltage of the at least one power supply; and, to send a power enable signal to the power supply to supply power to the storage enclosure.

22. A storage enclosure according to claim 12, and at least one disk drive module received in a bay, wherein the power control circuitry is arranged to receive power from said at least one power supply; to selectively enable said at least one disk drive module; and, to signal said power supply to latch its output.
